(19) United States
(12) Patent Application Publication
(10) Pub. No.: US 2006/0245748 A1
(43) Pub. Date: Nov. 2, 2006

(54) METHOD AND APPARATUS FOR TESTING AND ADJUSTING FOCUS OF AN IMAGING DEVICE

(76) Inventors: Chin-Kang Chuang, Taipei City (TW); Chao-Min Liao, Taipei Hsien (TW); Chia-Chang Li, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/380,216

(22) Filed: Apr. 26, 2006

(30) Foreign Application Priority Data
Apr. 27, 2005 (TW) 094113462

(51) Int. Cl. G03B 13/18

(52) U.S. Cl. 396/89

(57) ABSTRACT

A focus-adjusting apparatus and platform of an imaging device includes a base, a holding device, a gear set, an imaging device and a stepping motor. The imaging device is disposed on the base during the focus-adjusting process and can be removed from the base after the focus-adjusting process. The stepping motor adjusts the focus of the imaging device and an image-processing unit calculates and records the modulation transfer function of the imaging device. The focus of the imaging device is set to a value with which the imaging device has the optimum modulation transfer function.

### BACKGROUND OF THE INVENTION

1. Field of the Invention

The invention relates to a focus-adjusting apparatus, platform and method of an imaging device, and more particularly, to a focus-adjusting apparatus, platform and method of an imaging device that performs focus-adjustment with a stepping motor based on a modulation transfer function calculated by an image-processing device.

2. Description of the Prior Art

Generally speaking, there are two kinds of camera lenses: variable focus lenses and fixed focus lenses. A variable focus lens assembly contains several movable elements that permit changing of the effective focal length, such as between 18 to 55 mm or between 75 to 300 mm. When the distance between a photographer and an object remains constant, the shooting range can be adjusted with the movable elements in the variable lens. A fixed focus lens assembly provides fixed effective focal lengths, such as 24 mm or 85 mm. To change the shooting range of the fixed focus camera, the photographer has to move towards or away from the object. Fixed focus lens assemblies usually adopt charge-coupled device (CCD) or complementary metal-oxide semiconductor (CMOS) as optical sensors. The distance between the lens and the optical sensor in a fixed focus lens assembly has to be adjusted in order to achieve best performance.

Conventionally, there are two methods for performing focus-adjustment in a fixed focus lens assembly. In a first prior art method, the distance between the optical sensor and the lens of a fixed focus lens assembly is adjusted manually. Images measured by the optical sensor are firstly recorded and displayed on a display device. Image performance characteristics, such as contrast and brightness, are observed with human eyes and then the focal length of the fixed focus lens assembly is manually adjusted for improving image quality. This method depends largely on personal judgment of the focus-adjusting operator and the accuracy also varies accordingly. Also, it requires time to have qualified and experienced focus-adjusting operators and a focus-adjusting operator cannot perform the task on several fixed focus lens assemblies at the same time. Therefore, it often requires a lot of focus-adjusting equipment and operators in mass production and the manufacturing cost is quite considerable.

Another prior method for adjusting the focal length of a fixed focus lens assembly manually adjusts the distance between the optical sensor and the lens and records images measured by the optical sensor. Based on the recorded images, a modulation transfer function (MTF) of the fixed focus lens assembly is calculated using a computer. Then the focal length of the fixed focus lens assembly is adjusted to a calculated location where, based on the calculations of the computer, the fixed focus lens assembly has the optimum modulation transfer function. However, the modulation transfer functions depend on certain testing parameters that are easily influenced by the testing environment, such as auto exposure (AE) and auto white balance (AWB). This prior method does not consider these environmental impacts during the testing process and misjudgments of the optimum modulation transfer functions often occur. Therefore, the calculated focal length obtained in the above-mentioned method merely serves as a reference value and further focus-adjusting steps are still needed.

### SUMMARY OF THE INVENTION

It is therefore a primary objective of the claimed invention to provide a focus-adjusting apparatus and platform of an imaging device in order to solve the above-mentioned problems.

The claimed invention discloses a focus-adjusting apparatus of an imaging device including a base; an imaging device including a lens disposed at the base during focus-adjustment and removed from the base after focus-adjustment; a holding device coupled to the lens during focus-adjustment and detached from the lens after focus-adjustment; a gear set coupled to the holding device for driving the holding device; and a stepping motor for driving the gear set.

The claimed invention further discloses a focus-adjusting platform for adjusting focus of an imaging device including an imaging device including a lens and a sensor for sensing light from the lens and a focus-adjusting apparatus. The focus-adjusting apparatus comprises a lower base; an upper base, one side of the upper base being capable of attaching and detaching with the lower base; a holding device capable of attaching and detaching with the lens for holding the imaging device; a gear set coupled to the holding device for driving the holding device; and a stepping motor for driving the gear set.

The claimed invention further discloses a method for adjusting focus of an imaging device including adjusting focus of an imaging device using a stepping motor; measuring a parameter of an image measured by the imaging device; determining an optimum value of the parameter; and setting the focus of the imaging device to a value with which the optimum value of the parameter is obtained.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a focus-adjusting apparatus according to the present invention.

FIG. 2 is a top-view diagram of the focus-adjusting apparatus in FIG. 1.

FIG. 3 is a diagram of a circuit positioner of the focus-adjusting apparatus in FIG. 1.

FIG. 4 is a diagram of a holding device and a gear of the focus-adjusting apparatus in FIG. 1.

FIG. 5 is a top-view diagram of the holding device in FIG. 4.

FIG. 6 is a block diagram illustrating the operations of the focus-adjusting apparatus in FIG. 1 and an image-processing device.

FIG. 7 is a flowchart illustrating a method for performing focus-adjustment according to the present invention.

### DETAILED DESCRIPTION

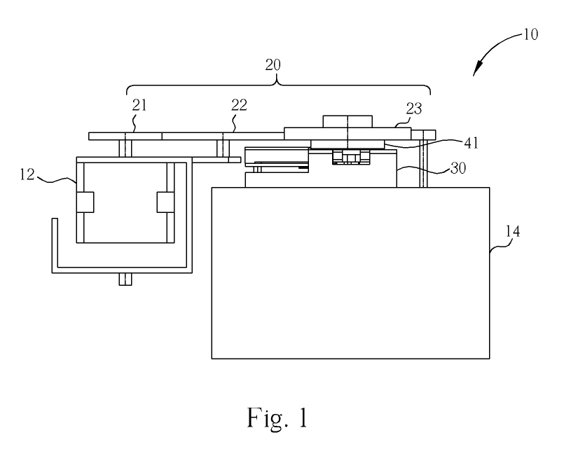

Please refer to FIG. 1 for a diagram illustrating a focus-adjusting apparatus 10 according to the present invention. The focus-adjusting apparatus 10 includes a stepping motor 12, a gear set 20, a circuit positioner 30, a holding device 41 and a base stand 14. The gearing wheel set 20 includes a first gear 21, a second gear 22 and a third gear 23.

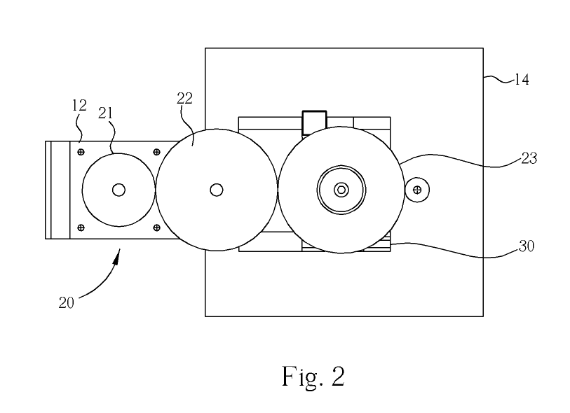

Please refer to FIG. 2 for a top view of the focus-adjusting apparatus 10. FIG. 2 gives better illustrations on the structure of the gear set 20. In the gear set 20, the first gear 21 is disposed on the stepping motor 12, the third gear 23 is disposed on the circuit positioner 30, and the second gear 22 is disposed between the first gear 21 and the second gear 23. The stepping motor 12 drives the focus-adjusting apparatus 10 by firstly driving the first gear 21, which in turn drives the second gear 22, which then drives the third wheel 23. The present invention can include three gears as shown in FIG. 2, or other numbers of gears depending on different designs and structures.

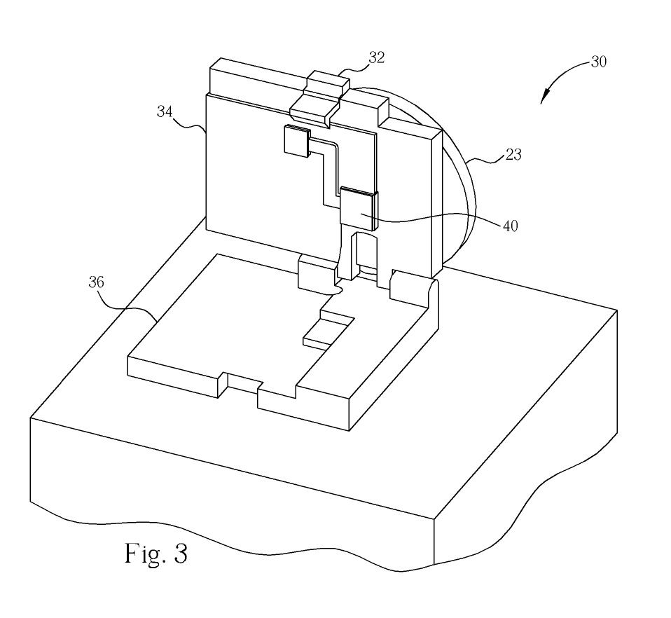

Please refer to FIG. 3 for a diagram of the circuit positioner 30. The circuit positioner 30 includes a latch 32, an upper base 34 and a lower base 36. The upper base 34 is coupled to a lens of an imaging device 40. One side of the upper base 34 is connected to one side of the lower base 36 such that the upper base 34 is capable of moving away and towards the lower base 36 by pivoting about the connection. The latch 32 can hold another side of the upper base 34 and the lower base 36 together. In the circuit positioner 30 shown in FIG. 3, the latch 32 is open, which means the upper base 34 and the lower base 36 are connected on one side, and are open on another side with a certain angle. Therefore, the imaging device 40 can easily be disposed. After the imaging device 40 is disposed, the latch 32 holds that side of the upper base 34 and the lower base 36 together. Therefore, the circuit positioner 30 provides the imaging device 40 with a testing environment having little environmental interference, thereby increasing the accuracy of focus-adjustment by reducing variations of parameters, such as AE and AWB. Based on different structures and designs, the circuit positioner 30 can have different appearances and provide different means of holding the upper and lower bases together.

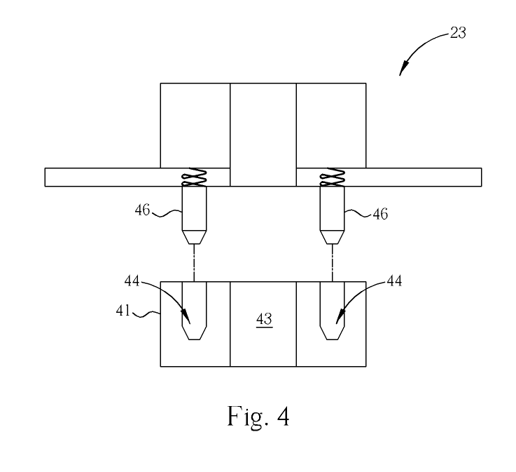

Please refer to FIG. 4 for a diagram illustrating the holding device 41 and the third gear 23. The holding device 41 includes a positioning hole 43 in which the lens of the imaging device 40 can be disposed and therefore connected to the holding device 41. The holding device 41 also includes one or a plurality of sockets 44 and the third gear 23 includes one or a plurality of screws 46 matching the sockets 44. When the screws 46 and the sockets 44 are jointed, the holding device 41 and the third gear 23 are connected. The stepping motor 12 drives the gear set 20 and the third gear wheel 23 of the gear set 20 then drives the holding device 41, in which the lens of the imaging device 40 disposed within the positioning hole 43 in turn moves accordingly.

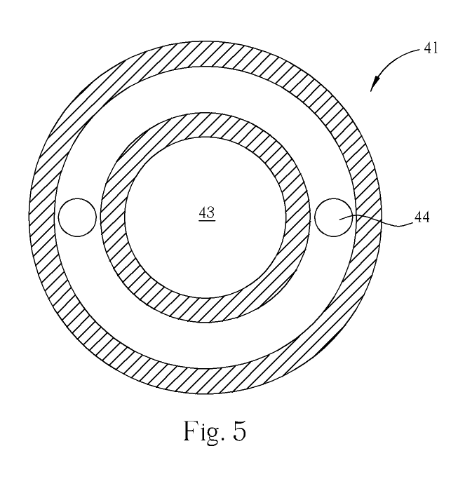

Please refer to FIG. 5 for a top view of the holding device 41. Depending on the shapes of lenses of different imaging devices, the positioning hole 43 of the holding device 41 can have corresponding geometric shapes. In the embodiment shown in FIG. 5, the lens of the imaging device 40 is circular and thus the positioning hole 43 is also of circular shape. However, the positioning hole 43 can have other shapes when used for other imaging devices.

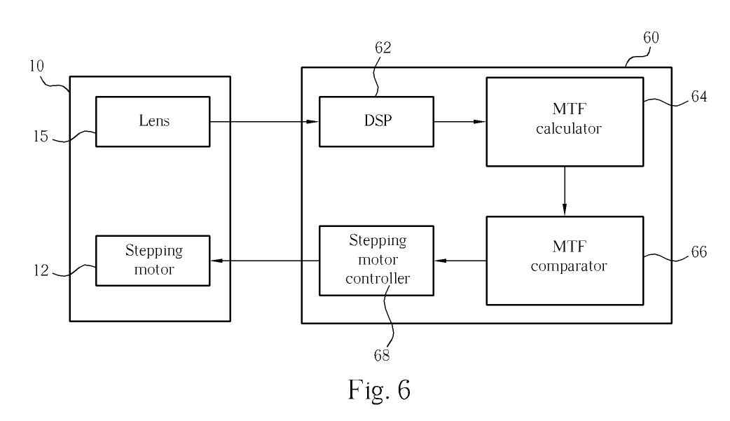

Please refer to FIG. 6 for a block diagram illustrating the operations of the focus-adjusting apparatus 10 and an image-processing device 60. The image-processing device 60 is coupled to the focus-adjusting apparatus 10 and includes an application specific integrated circuit (ASIC), a digital signal processor (DSP) 62, a modulation transfer function (MTF) calculator 64, an MTF comparator 66, and a stepping motor controller 68. When the focus-adjusting apparatus 10 is operating, the focal length of a lens 15 of the imaging device 40 is set to a certain value by adjusting the stepping motor 12. The DSP 62 receives and processes image signals measured by the lens 15 at this focal length and the MTF calculator 64 calculates an MTF of the received image signals. Based on the calculated MTF of the received signals and other previously calculated MTFs at other focal lengths, the MTF comparator 66 determines whether an optimum MTF can be obtained. If the optimum MTF can be obtained, the stepping motor controller 68 sends the optimum MTF to the stepping motor 12, which in turn adjusts the lens 15 to a position where the optimum MTF was obtained. If the optimum MTF cannot be obtained, the focal length of the lens 15 of the imaging device 40 is set to another value by adjusting the stepping motor 12, until the optimum MTF can be obtained.

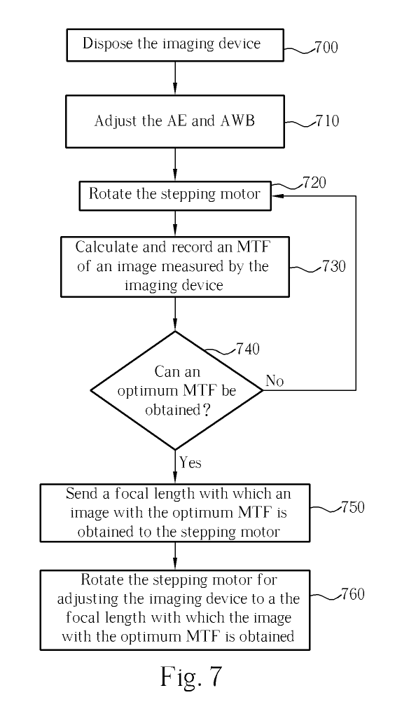

Please refer to FIG. 7 for a flow chart illustrating a method for performing focus-adjustment using the focus-adjusting apparatus 10 according to the present invention. FIG. 7 includes the following steps:

Step 700: Dispose the imaging device 40 on the focus-adjusting apparatus 10;

Step 710: Adjust the AE and AWB of the imaging device 40;

Step 720: Rotate the stepping motor 12 with a predetermined step and in a predetermined direction for adjusting the focal length of the lens 15 of the imaging device 40;

Step 730: Calculate and record an MTF of an image measured by the imaging device 40 after the stepping motor has been adjusted with the predetermined step and in the predetermined direction;

Step 740: Determine if an optimum MTF can be obtained; if the optimum MTF can be obtained, execute step 750; if the optimum MTF cannot be obtained, execute step 720;

Step 750: Send a focal length with which the lens 15 of the imaging device 40 measures an image with the optimum MTF to the stepping motor 12; and

Step 760: Rotate the stepping motor 12 for adjusting the lens 15 of the imaging device 40 to the focal length with which the image with the optimum MTF is obtained.

In the flowchart shown in FIG. 7, the present invention adopts the MTF for determining the best focal length of the imaging device 40. However, other parameters can also be adopted for determining the best focal length of the imaging device 40.

The focus-adjusting apparatus 10 provides the imaging device 40 with a testing environment having little interference. Before performing focus adjustment, the auto exposure and auto white balance of the imaging device 40 are adjusted and set to predetermined values to prevent these parameters from impacting the accuracy of subsequent focus-adjustment. The stepping characteristics of the stepping motor 12 allow accurate focus adjustment of the imaging device 40. The image-processing device dynamically calculates and records modulation transfer functions of images measured with different focal lengths and determines an optimum modulation transfer function. Then the data is sent to the stepping motor for adjusting the focal length of the imaging device to a value where the optimum modulation transfer function is obtained.

Compared to the prior art, the present invention provides a focus-adjust apparatus and a method that can perform accurate focus-adjustment based on a modulation transfer function and a testing environment with less interference. In conclusion, the present invention offers an automatic, accurate, stable and lost-cost focus-adjusting platform.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A focus-adjusting apparatus of an imaging device including: a base;
an imaging device including a lens disposed at the base during focus-adjustment and removed from the base after focus-adjustment;
a holding device coupled to the lens during focus-adjustment and detached from the lens after focus-adjustment;
a gear set coupled to the holding device for driving the holding device; and
a stepping motor for driving the gear set.

2. The apparatus of claim 1, wherein the holding device includes a positioning hole whose geometric shape is capable of changing to fit the lens of the imaging device.

3. The apparatus of claim 1, wherein the gear set includes a screw and the holding device includes a socket matching the screw for connecting the gear set and the holding device.

4. The apparatus of claim 1, wherein the lens is a fixed-focus lens.

5. The apparatus of claim 1 further comprising an image-processing device coupled to the imaging device for processing images captured by the imaging device.

6. The apparatus of claim 5, wherein the image-processing device is an application specific integrated circuit (ASIC).

7. The apparatus of claim 5, wherein the image-processing device includes a digital signal processor (DSP).

8. The apparatus of claim 5, wherein the image-processing device includes a modulation transfer function calculator.

9. The apparatus of claim 5, wherein the image-processing device includes a modulation transfer function comparator.

10. The apparatus of claim 9, wherein after the imaging device is disposed on the holding device, an auto-exposure and an auto white balance of the imaging device are adjusted.

11. The apparatus of claim 10, wherein after the auto-exposure and the auto white balance of the imaging device are adjusted, the stepping motor drives the gear set for adjusting focus of the imaging device.

12. The apparatus of claim 11, wherein after the stepping motor drives the gear set for adjusting focus of the imaging device, a modulation transfer function of an image measured by the imaging device is calculated and recorded, and it is determined whether the modulation transfer function is an optimum value.

13. The apparatus of claim 12, wherein after the optimum value modulation transfer function is determined, a focus of the imaging device where the optimum value modulation transfer function is obtained is sent to the stepping motor.

14. The apparatus of claim 13, wherein after sending the focus of the imaging device where the optimum value modulation transfer function is obtained to the stepping motor, the stepping motor adjusts a focus of the imaging device according to the focus of the imaging device where the optimum value modulation transfer function is obtained.

15. A focus-adjusting platform for adjusting focus of an imaging device including:
an imaging device including a lens and a sensor for sensing light from the lens; and
a focus-adjusting apparatus, comprising:
a lower base;
an upper base, one side of the upper base being capable of attaching and detaching with the lower base;
a holding device capable of attaching and detaching with the lens for holding the imaging device;
a gear set coupled to the holding device for driving the holding device; and
a stepping motor for driving the gear set.

16. The platform of claim 15, wherein the holding device includes a positioning hole whose geometric shape is capable of changing to fit the lens of the imaging device.

17. The platform of claim 15, wherein the gear set includes a screw and the holding device includes a socket matching the screw for connecting the gear set and the holding device.

18. The platform of claim 15, wherein one side of the upper base is connected to one side of the lower base such that the upper base is capable of moving away and towards the lower base by pivoting about the connection.

19. The platform of claim 15, wherein the focus-adjusting apparatus further includes a latch disposed at one side of the upper base for holding the upper base and the lower base together.

20. The platform of claim 15, wherein the lens is a fixed-focus lens.

21. A method for adjusting focus of an imaging device including:
adjusting focus of an imaging device using a stepping motor;
measuring a parameter of an image measured by the imaging device;
determining an optimum value of the parameter; and
setting the focus of the imaging device to a value with which the optimum value of the parameter is obtained.

22. The method of claim 21 further comprising:
adjusting an auto-exposure and an auto white balance of the imaging device before adjusting the focus of the imaging device using the stepping motor.

23. The method of claim 21 further comprising:
sending the value of the focus of the imaging device with which the optimum value of the parameter is obtained to the stepping motor.

24. The method of claim 21, wherein measuring the parameter of the image measured by the imaging device is measuring a modulation transfer function of the image measured by the imaging device.
